(19) United States
(12) Patent Application Publication
(10) Pub. No.: US 2011/0272863 A1
(43) Pub. Date: Nov. 10, 2011

(54) PREFORM HEATER USING GAS, METHOD, AND APPARATUS

(76) Inventor: Peter Lindner, Langquaid (DE)

(21) Appl. No.: 13/144,265

(22) PCT Filed: Feb. 16, 2010
(86) PCT No.: PCT/EP10/51884

§ 371 Date: Jul. 12, 2011

(30) Foreign Application Priority Data
Feb. 20, 2009 (DE) 10 2009 009 867.4

(51) Int. Cl. B29C 49/64

(52) U.S. Cl. 264/535; 425/526

(57) ABSTRACT

The invention relates to an apparatus and a method for producing and treating plastic containers (10), especially preforms (10), comprising at least one heating device (1) for heating the preforms (10) by means of at least one heat-emitting energy source, a downstream blow molding station (3) for expanding the heated preforms (10), and a conveying device (5) which conveys the preforms (10) along a travel path P through the heating device (1). The energy source (1) includes a gas-operated heating element.

The present invention relates to an apparatus for the production and treatment of containers, in particular pre-forms, consisting of plastics material, according to the preamble of claim 1, as well as to a method for the production and treatment of containers consisting of plastics material, according to the preamble of claim 9.

In packaging technology the importance of so-called PET bottles in the field of plastics material containers has been increasing for some years. PET bottles of this type are produced and processed from a so-called PET pre-form by means of a thermal method, in which case the PET pre-form represents the injection-moulded blank of the PET bottle.

Apparatus of the type defined have in this case at least one heating device for heating the pre-forms, downstream of which a blowing station for expanding the heated pre-forms is arranged, as well as a conveying apparatus which conveys the pre-forms through the heating device. The heating station and the blowing station are provided with pre-forms in an unbroken manner and ideally operate at maximum capacity and maximum efficiency. In this case the structural outlay and the energy requirement of known apparatus is not inconsiderable. In addition, the electrical heating elements customarily used in the heating stations have the drawback that they require a comparatively long time to achieve a desired temperature in a precise manner at the location of a pre-form to be treated.

Consequently, the object of the present invention is to make available an apparatus and a method with the aid of which the heating of plastics material containers of this type is facilitated in such a way that a plurality of containers are capable of being simultaneously and rapidly heated and cooled in each case and that the expenditure of energy for heating is kept comparatively low.

An essential aspect of the invention lies in the fact that the apparatus according to the invention for the production and treatment of containers, in particular pre-forms, consisting of plastics material, containing at least one heating device for heating the pre-forms and with at least one energy source emitting heat, a blowing station arranged downstream for expanding the heated pre-forms, and a conveying apparatus which conveys the pre-forms along a conveying path through the heating device, has a heating element operated with gas. In this case the heating element preferably has at least one gas burner. It is advantageous for continuously regulated burners to be used.

A further advantage of the apparatus according to the invention is that gas is frequently available under substantially more favourable conditions for the operator of an apparatus of this type than is electrical current.

In this case, in accordance with the temperatures required for the treatment of pre-forms, usually <140° C., the gas burner is preferably suitable in particular for the flameless combustion of gaseous hydrocarbons. By way of example, liquefied gas can be used, in which case the vapour phase is withdrawn directly out of a liquefied gas storage container and is fed to the burner. This liquefied gas storage container can be a constituent part of the treatment plant. In addition, the use of natural gas is also possible, the storage of fuel being dispensed with in this case.

It is preferred for the temperature of the pre-forms to be capable of being varied over at least several degrees Celsius within a period of from 1 to 10 s during the heating. In this way, the heating element operated with gas has the considerable advantage that it is possible to pass through steep temperature gradients.

It is particularly preferred for the heating device to have, in addition to the at least one heating element operated with gas, a further energy source which is different therefrom. In this way, basic heat can be provided by this, for example by an electrical heating element, and the end parameters on the pre-form can be achieved in a purposeful manner with the gas burner or vice versa, i.e. it would also be possible to produce a certain basic heat by way of the gas-operated heating means and to set the end parameters on the pre-form with a different energy source. In this way, both an energy-saving and a significantly localized heating of the pre-forms to be treated is achieved.

It is preferable for the heating element operated with gas to be arranged in the heating device of the treatment plant in such a way that it is suitable for both direct and/or indirect heating of the containers. In this way, the heat produced in the gas burner either can be used directly on the pre-form or can be supplied to the latter indirectly by way of an interposed element at a distance. The heating device according to the invention is therefore suitable both for a direct and for an indirect heating of the pre-form.

It is particularly preferred for the heating element operated with gas to be arranged at the side of and/or below the conveying path of the containers conveyed by means of the conveying device. In this way, heating of the thread area of the pre-form is advantageously avoided

It is advantageous for an air movement device to be arranged in the region of the heating device which contains the heating element operated with gas. This ensures a rapid distribution of the heat produced by the gas burner inside the heating device. The air movement device can be a fan for example.

A further essential aspect of the invention consists in the preparation of a method for the production and treatment of containers, in particular pre-forms, consisting of plastics material, with at least one energy source emitting heat, in which the containers are heated with a heating device containing the energy source and are conveyed by a conveying apparatus through the heating device, the containers being heated by a heating element operated with gas.

In this case the heating of the containers is carried out after the heating element is switched on preferably at temperature gradients of at least 5° C./s.

In the same way the cooling of the containers is carried out after the heating element is switched off at temperature gradients of at least 5° C./s.

It is preferable for at least one gas to be burnt in order to heat the containers.

Advantages and expedient features may be seen from the following description in conjunction with the drawing. In the drawing

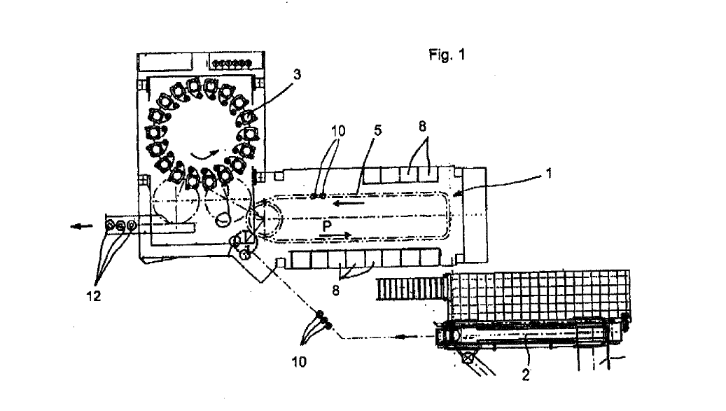

FIG. 1 is a diagrammatic plan view of a heating device contained in a stretch blow moulding machine.

The stretch blow moulding machine as shown in FIG. 1 comprises a plurality of blowing stations 3 which are arranged in each case on a blowing wheel capable of being driven in a continuous manner, and a heating device 1 arranged upstream of these blowing stations and having a conveying apparatus 5—circulating in a continuous manner in the direction of the arrows—for the pre-forms as well as stationary heating elements or gas burners 8. The reference letter P in this case designates the conveying path of the pre-forms inside the heating device In this case it is possible for the individual pre-forms 10 to be gripped by gripping elements and to be conveyed upright through the heating device 1. The individual heating elements 8 are preferably arranged in such a way that an aperture of the pre-forms 10 is not heated.

In this case the heating elements 8 or gas burners are arranged at the side of or below the conveying path P of the pre-forms 10 conveyed by means of the heating device 5. Only in the case of indirect heating of the pre-forms are the heating elements 8 arranged away from the conveying region of the pre-forms 10. In the case of an arrangement for direct heating there is advantageously an extremely rapid reaction time, in which case individual zones of the pre-form 10 to be treated can be heated in a purposeful manner. This is associated with a reduction in the energy consumption within the stretch blow moulding machine as a whole. Here the individual heating elements are shown outside the conveying path P.

It would also be possible, however, for heating elements 8 also to be arranged inside the conveying path. It would also be possible for burners to be provided which operate a plurality of heating elements 8, in which case a flow of heated air could be directed towards specified areas of the pre-forms depending upon requirements.

The reference number 2 relates to a sorting unit which sorts the pre-forms so that they arrive in the same orientation at the heating device 1. In this case the pre-forms 10 are guided separately in the heating device 1. The individual heating elements 8 are advantageously capable of being controlled independently of one another. The reference number 12 relates to the already finished blow moulded containers.

All the features disclosed in the application documents are claimed as being essential to the invention, insofar as they are novel either individually or in combination as compared with the prior art.

1. An apparatus for the production and treatment of containers, in particular pre-forms comprised of plastics material, containing at least one heating device for heating the pre-forms and with at least one energy source emitting heat, a blowing station arranged downstream for expanding the heated pre-forms, and a conveying apparatus which conveys the pre-forms along a conveying path (P) through the heating device, wherein the energy source has a heating element operated with gas.

2. The apparatus according to claim 1, wherein the heating element has at least one gas burner.

3. The apparatus according to claim 1, wherein the gas burner is suitable in particular for the flameless combustion of gaseous hydrocarbons.

4. The apparatus according to claim 1, wherein the temperature of the pre-forms is capable of being varied over at least several ° C. within a period of from 1 to 10 s.

5. The apparatus according to claim 1, wherein the heating device has, in addition to the at least one heating element operated with gas, a further energy source which is different therefrom.

6. The apparatus according to claim 1, wherein the heating element operated with gas is arranged in such a way that it is suitable for direct or indirect heating of the containers.

7. The apparatus according to claim 1, wherein the heating element operated with gas is arranged at the side of and/or below the conveying path (P) of the containers conveyed by using the conveying device.

8. The apparatus according to claim 1, wherein an air movement device is arranged in the region of the heating device which contains the heating element operated with gas.

9. A method for the production and treatment of containers, in particular pre-forms comprised of plastics material, with at least one energy source emitting heat, wherein the containers are heated with a heating device containing the energy source and are conveyed by a conveying apparatus through the heating device, wherein the containers are heated by a heating element operated with gas.

10. The method according to claim 9, wherein the heating of the containers is carried out after the heating element is switched on at temperature gradients of at least 5° C./s.

11. The method according to claim 9, wherein the cooling of the containers is carried out after the heating element is switched off at temperature gradients of at least 5° C./s.

12. The method according to claim 9, wherein at least one gas is burnt in order to heat the containers.
